(19) United States
(12) Patent Application Publication
(10) Pub. No.: US 2021/0224035 A1
(43) Pub. Date: Jul. 22, 2021

(54) XIU-ACCUMULATING REGISTER, XIU-ACCUMULATING REGISTER CIRCUIT, AND ELECTRONIC DEVICE

(71) Applicant: BOE TECHNOLOGY GROUP CO., LTD., Beijing (CN)

(72) Inventor: Liming XIU, Beijing (CN)

(21) Appl. No.: 16/099,479

(22) PCT Filed: Jan. 5, 2018
(86) PCT No.: PCT/CN2018/071473

§ 371 Date: Nov. 7, 2018

(30) Foreign Application Priority Data
May 19, 2017 (CN) 201720569426.8

(51) Int. Cl. G06F 7/509

(52) U.S. Cl. CPC G06F 7/509

(57) ABSTRACT

The present disclosure relates to aft XIU-accumulating register, aft XIU-accumulating register circuit, and an electronic device. The XIU-accumulating register includes a first accumulating unit and a second accumulating unit. The first accumulating unit includes a first adder and a first register; the first adder is configured to accumulate fractional bit data of an accumulated variable, and the first register is configured to store an accumulated result of the fractional bit data and carry bit data of the accumulated result of the fractional bit data. The second accumulating unit includes a second adder and a second register; the second adder is configured to accumulate integer bit data of the accumulated variable, and the second register is configured to store an accumulated result of the integer bit data.

### CROSS-REFERENCE TO RELATED APPLICATIONS

The present application is based upon International Application No. PCT/CN2018/071473, filed on Jan. 5, 2018, which is based upon and claims priority to Chinese utility model application No. 201720569426.8, filed on May 19, 2017, and the entire contents thereof are incorporated herein by reference.

### TECHNICAL FIELD

The present disclosure relates to the field of circuit technology, and in particular, to a XIU-accumulating register, a SIU-accumulating register circuit, and an electronic device.

### BACKGROUND

In the field of electrical engineering and computer science, many applications need to take into account long-term accumulation effect of a small quantity, that is, “error” accumulated over time, which needs to be realized by time accumulation task, and the key circuit component for performing this task is an accumulator.

The operation principle of the accumulator is shown in FIG. 1. In a binary system, a fixed quantity will be accumulated on itself continuously over time, and the result thereof is usually used for some kind of upper level signal processing. In this process, there are two notable features: (1) same quantity is added in each adding operation; (2) the “over-time” is realized with a clock signal, that is, time advances with clock cycle. This task is a very basic operation that is widely used in complex signal processing operations. In some cases, the fixed quantity (number) can be divided into an integer part and a fractional part; wherein, the fractional part represents the so-called “error”, that is, a small quantity that deviates from a target value, which contributes to the achievement of averaging-over-time result. Such application examples may include a fractional divider using a fractional-N frequency divider, an accumulator for using in a direct digital synthesizer (DDS), and the like,

In general, cost and performance of the accumulator is directly related to its size, the larger the size, the higher the cost, and the slower the speed. It should be understood that large size accumulators are required when large values need to be processed, thus requiring more resources (area and power).

It should be noted that the information disclosed in the background section above is only for enhancing the understanding of the background of the present disclosure, and thus may include information that does not constitute prior art known to those ordinary skilled in the art.

### SUMMARY

The present disclosure relates to a XIU-accumulating register, an XIU-accumulating register circuit, and an electronic device.

According to an aspect of the present disclosure, there is provided an XIU-accumulating register, including a first accumulating unit and a second accumulating unit. The first accumulating unit includes a first adder and a first register; the first adder is configured to accumulate fractional bit data of an accumulated variable, and the first register is configured to store an accumulated result of the fractional bit data and carry bit data of the accumulated result of the fractional bit data. The second accumulating unit includes a second adder and a second register; the second adder is configured to accumulate integer bit data of the accumulated variable, and the second register is configured to store an accumulated result of the integer bit data. The first register of the first accumulating unit is coupled to the second adder of the second accumulating unit to, in a next clock cycle, propagate the carry bit data of the accumulated result of the fractional bit data in a current clock cycle to the integer bit data for accumulation.

In an exemplary embodiment of the present disclosure, each of the first adder and the second adder includes an input terminal, a feedback terminal, and an output terminal. An input terminal of the first register is coupled to the output terminal of the first adder, and an output terminal of the first register is coupled to the feedback terminal of the first adder and the feedback terminal of the second adder. An input terminal of the second register is coupled to the output terminal of the second adder, and an output terminal of the second register is coupled to the feedback terminal of the second adder. The input terminal of the first adder receives the fractional bit data of the accumulated variable, and the input terminal of the second adder receives the integer bit data of the accumulated variable.

In an exemplary embodiment of the present disclosure, the first register includes a first sub-register and a second sub-register. The first sub-register is configured to store the accumulated result of the fractional bit data, and the second sub-register is configured to store the carry bit data of the accumulated result of the fractional bit data.

In an exemplary embodiment of the present disclosure, the output terminal of the first register is coupled to the feedback terminal of the first adder and the feedback terminal of the second adder so that: an output terminal of the first sub-register is coupled to the feedback terminal of the first adder; and an output of the second sub-register is coupled to the feedback terminal of the second adder.

In an exemplary embodiment of the present disclosure, the first accumulating unit has a multi-bit accumulating structure.

In an exemplary embodiment of the present disclosure, the first adder is a multi-bit adder and the adder for each bit corresponds to one first register.

In an exemplary embodiment of the present disclosure, the XIU-accumulating register further includes a clock-signal-receiving terminal for receiving a clock signal. At a rising edge phase or a falling edge phase of each clock cycle of the clock signal, the first register outputs the accumulated result of the fractional bit data and the carry bit data of the accumulated result of the fractional bit data, and the second register outputs the accumulated result of the integer bit data.

In an exemplary embodiment of the present disclosure, the accumulated variable is consisted of multi-bit binary values.

According to an aspect of the present disclosure, there is provided an XIU-accumulating register circuit, including a cascade of the XIU-accumulating registers described above.

According to an aspect of the present disclosure, there is provided an electronic device including the above XIU-accumulating register circuit.

It should be understood that the above general description and the following detailed description are merely exemplary and explanatory and are not limiting, of the present disclosure.

### BRIEF DESCRIPTION OF THE DRAWINGS

The drawings herein are incorporated into the specification and form part of the specification, showing the embodiments of the present disclosure and explaining the principle of the present disclosure together with the specification. It is apparent that the drawings in the following description are only some of the embodiments of the present disclosure, and other drawings may be obtained according to these drawings from those skilled in the art without creative labor.

FIG. 1 schematically shows a structural schematic diagram of an accumulator in the prior art;

FIG. 2 schematically shows a structural schematic diagram of an XIU-accumulating register in an exemplary embodiment of the present disclosure;

FIG. 3 schematically shows a structural schematic diagram of a XIU-accumulating register in an exemplary embodiment of the present disclosure.

### DETAILED DESCRIPTION

Example embodiments will now be described more fully with reference to the drawings. However, the example embodiments can be embodied in various forms and should not be construed as being limited to the examples set forth herein: rather, these embodiments are provided so that the present disclosure will be more comprehensive and complete, and the conception of the example embodiments will be fully conveyed to those skilled in the art. The described features, structures, or characteristics may be combined in any suitable manner in one or more embodiments.

In addition, the drawings are merely schematic representations of the present disclosure and are not necessarily drawn to scale. The same reference numerals in the drawings denote the same or similar parts, and the repeated description thereof will be omitted. Some of the block diagrams shown in the drawings are functional entities and do not necessarily have to correspond to physically or logically separate entities. These functional entities may be implemented in software, or implemented in one or more hardware modules or integrated circuits, or implemented in different network and/or processor devices and/or microcontroller devices.

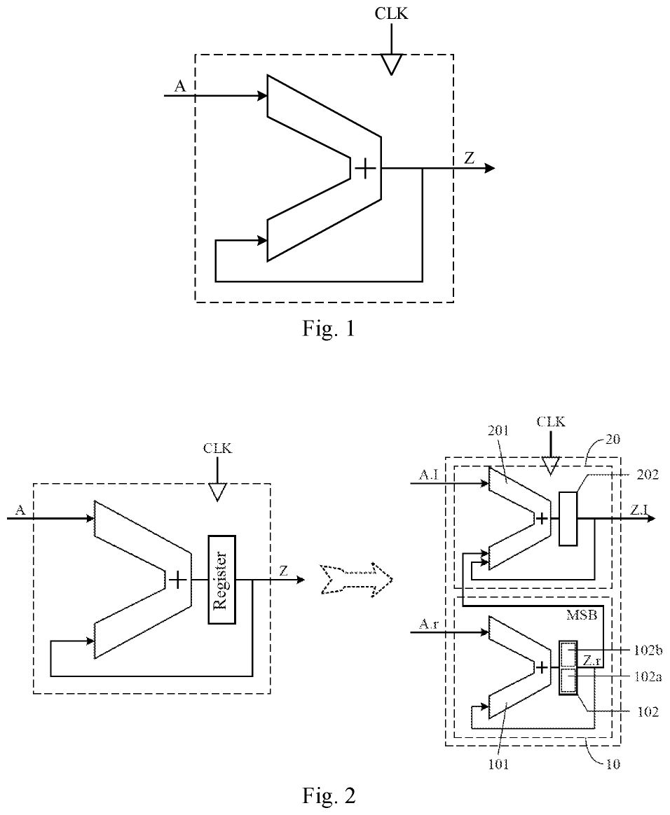

The present example embodiment provides an XIU-accumulating register. As shown in FIG. 2, the XIU-accumulating register includes a first accumulating unit 10 and a second accumulating unit 20. The first accumulating unit 10 may include a first adder 101 and a first register 102; the first adder 101 is configured to accumulate fractional bit data, i.e., data of fractional bit, of an accumulated variable, and the first register 102 is configured to store an accumulated result of the fractional bit data and carry bit data, i.e., data of carry bit, of the accumulated result of the fractional bit data. The second accumulating unit 20 may include a second adder 201 and a second register 202; the second adder 201 is configured to accumulate integer bit data, i.e., data of integer bit, of the accumulated variable, and the second register 202 is configured to store an accumulated result of the integer bit data. The first register 102 of the first accumulating unit 10 is coupled to the second adder 201 of the second accumulating unit 20 to, in a next clock cycle, propagate the carry bit data of the accumulated result of the fractional bit data in a current clock cycle to the integer bit data for accumulation.

It should be noted that the accumulated variable is a fixed value, and the accumulated variable may be composed of multi-bit binary values; in the value composition of the binary system, the accumulated variable A may be divided into an integer part A.I and a fractional part As, correspondingly the accumulated result Z may also include an integer part Z.I and a fractional part Z.r, wherein the carry bit data of the fractional part is determined by the Most Significant Bit (MSB) of the fractional part.

In the XIU-accumulating register provided by the exemplary embodiments of the present disclosure, the fractional bit data of the accumulated variable is processed by using the first accumulating unit 10, the integer bit data of the accumulated variable is processed by using the second accumulating unit 20, and once the carry bit data is generated by the accumulated result of the fractional bit data, the carry bit data is stored in the register firstly, and then is propagated to the integer bit data for accumulation in the next clock cycle. In this way, the accumulator does not need to wait for the carry information of the fractional data in the current clock cycle in the process of the accumulating operation, so the operation speed is only related to the number of bits of the integer bit data, and is not limited by the size of the fractional bit data. Therefore, it is advantageous to achieve high-speed operation, and the area and power can be effectively reduced for a large-sized accumulator.

Based on the above structure, the accumulator should further include a clock-signal-receiving terminal for receiving a clock signal; at a rising edge phase or a falling edge phase of each clock cycle of the clock signal, the first register 102 outputs the accumulated result of the fractional bit data and the carry bit data of the accumulated result of the fractional bit data, and the second register 202 outputs the accumulated result of the integer bit data.

In some application cases, the fractional part of the accumulating operation is only used to achieve the effect of “averaging-over-time”, so in the actual operation, only the integer part of the accumulating variable and the carry bit data of the fractional part need to be considered, that is, only the overflow of the most significant bit MSB from the fractional bit data will affect the final output of the accumulation process. Based on this, when considering such an accumulation operation, the true accumulated result of the fractional part is not important, as long as the carry information from the fractional part can be ensured to be accurate, therefore, the accumulator provided in this embodiment can process the integer part and the fractional part of the accumulated variable independently, only the carry information from the fractional part is obtained, and the accuracy of the carry bit data can be guaranteed. within a given time range.

Based on this, the structure of the first accumulating unit 10 may be a XIU-accumulating register for processing the accumulation of the fractional parts, and only considering the carry information of the accumulated result of the fractional part, and the second accumulating unit 20 can be implemented by a conventional accumulator. The theory has proved that, in the long-term effect, the carry bit data of the XIU-accumulating register is the same as the carry bit data of the conventional accumulator, and therefore there is no erroneous influence on the accumulated result of the present embodiment.

In the example embodiment, the first adder 101 and the second adder 201 may each include an input terminal, a feedback terminal, and an output terminal; an input terminal of the first register 102 is coupled to the output terminal of the first adder 101, an output terminal of the first register 102 is coupled to the feedback terminal of the first adder 101 and the feedback terminal of the second adder 201; an input terminal of the second register 202 is coupled to the output terminal of the second adder 201, and an output terminal of the second register 202 is coupled to the feedback terminal of the second adder 201. The input terminal of the first adder 101 receives the fractional bit data of the accumulated variable, and the input terminal of the second adder 201 receives the integer bit data of the accumulated variable.

It can be seen that the input data of the first adder 101 includes the fractional bit data of the accumulated variable received by the input terminal thereof and the accumulated result of the first adder 101 in the previous clock cycle received by the feedback terminal thereof. The input data of the second adder 201 includes the integer bit data of the accumulated variable received by the input terminal thereof, and the carry bit data of the accumulated result of the first adder 101 in the previous cycle and the accumulated result of the second adder 201 in the previous cycle received by the feedback terminal thereof.

It should be noted that only when there is carry bit data in the accumulated result of the fractional bit data, the carry bit data is fed back to the integer bit data for accumulation.

In order to separately store the accumulated result of the fractional bit data and the generated carry bit data thereof, thus facilitating the output of the carry bit data, the first register 102 in this embodiment may include a first sub-register 102a and a second sub-register 102b; the first sub-register 102a is configured to store the accumulated result of the fractional bit data, and the second sub-register 102b is configured to store the carry bit data of the accumulated result of the fractional bit data.

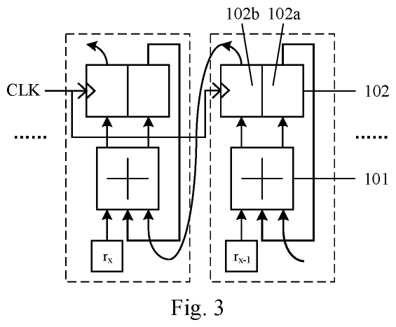

Based on this, as shown in FIG. 3, the output terminal of the first sub-register 102a can be coupled to the feedback terminal of the first adder 101 to propagate the accumulated result of the fractional bit data stored to the feedback terminal of the first adder 101 in the next clock cycle. The output terminal of the second sub-register 102b can be coupled to the feedback terminal of the second adder 201 to propagate the carry bit data of the accumulated result of the fractional bit data stored to the feedback terminal of the second adder 201 in the next dock cycle,

In the accumulator structure shown in FIG. 3, the first accumulating unit 10 may, have a multi-bit accumulating structure or a single-bit accumulating structure, and the second. accumulating unit 20 may also have a multi-bit accumulating structure or a single-bit accumulating structure.

It should be noted that this embodiment only defines the structure of the first accumulating unit 10, and the second accumulating unit 20 may adopt a conventional accumulator structure.

Based on this, in the first accumulating unit 10, the first adder 101 may be a multi-bit adder, and the adder for each bit corresponds to one first register 102, which specifically includes the first sub-register 102a and the second sub-register 102b, for storing the accumulated result of the fractional bit data and the carry bit data thereof respectively, and. outputting the same in the next clock cycle.

In this way, the accumulated result for lower bit is propagated to the adder for the higher bit in the next clock cycle, thereby not only ensuring the calculation accuracy but also increasing the operation speed.

The present example embodiment also provides an XIU-accumulating register circuit including N cascaded accumulators described above. The accumulated result of the previous stage accumulator is propagated to the next stage accumulator in the next clock cycle, and after N clock cycles, the accumulated result of the first stage accumulator is propagated to the last stage accumulator.

It can be seen that the XIU-accumulating register circuit does not need to wait for the carry information of the fractional data in the current clock cycle in the process of the accumulation operation, so the operation speed is only related to the number of bits of the integer bit data, and is not limited by the size of the fractional data, thus facilitating high-speed operation, and the area and power can be effectively reduced for large-sized accumulators.

The present example embodiment also provides an electronic device including the above-described XIU-accumulating register circuit.

The electronic device may include, for example, a fractional frequency divider using a fractional-N frequency divider, an accumulator for using in a direct digital frequency synthesizer (DDS), and the like

It should be noted that although several modules or units of equipment for action execution are mentioned in the detailed description above, such division is not compellent. Actually, features and functions of two or more of the modules or units described above may be embodied in one module or unit in accordance with the embodiments of the present disclosure. Conversely, the features and functions of one module or unit described above may be further achieved by multiple modules or units.

In addition, although each step of the method of the present disclosure are described in a specific order in the drawings, it is not required or implied that the steps must be performed in the specific order, or all the steps shown must be performed to achieve the desired result. Additionally or alternatively, certain steps may be omitted, multiple steps may be combined into one step, and/or one step may be decomposed into multiple steps and the like.

Other embodiments of the present disclosure will be readily apparent to those skilled in the art upon consideration of the specification and practice of the disclosed invention herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are to be only considered as illustrative, the truth scope and spirit of the present disclosure are pointed out by appended claims.

1. A XIU-accumulating register, comprising a first accumulating unit and a second accumulating unit;
the first accumulating unit comprises a first adder and a first register; the first adder is configured to accumulate fractional bit data of an accumulated variable, and the first register is configured to store an accumulated result of the fractional bit data and carry bit data of the accumulated result of the fractional bit data;
the second accumulating unit comprises a second adder and a second register; the second adder is configured to accumulate integer bit data of the accumulated variable, and the second register is configured to store an accumulated result of the integer bit data;
wherein the first register of the first accumulating unit is coupled to the second adder of the second accumulating unit to, in a next clock cycle, propagate the carry bit data of the accumulated result of the fractional bit data in a current clock cycle to the integer bit data for accumulation.

2. The XIU-accumulating register according to claim 1, wherein each of the first adder and the second adder comprises an input terminal, a feedback terminal, and an output terminal;
an input terminal of the first register is coupled to the output terminal of the first adder, and an output terminal of the first register is coupled to the feedback terminal of the first adder and the feedback terminal of the second adder;
an input terminal of the second register is coupled to the output terminal of the second adder, and an output terminal of the second register is coupled to the feedback terminal of the second adder;
wherein the input terminal of the first adder receives the fractional bit data of the accumulated variable, and the input terminal of the second adder receives the integer bit data of the accumulated variable.

3. The XIU-accumulating register according to claim 2, wherein the first register comprises a first sub-register and a second sub-register; and
wherein the first sub-register is configured to store the accumulated result of the fractional bit data, and the second sub-register is configured to store the carry bit data of the accumulated result of the fractional bit data.

4. The XIU-accumulating register according to claim 3, wherein the output terminal of the first register is coupled to the feedback terminal of the first adder and the feedback terminal of the second adder so that:
an output terminal of the first sub-register is coupled to the feedback terminal of the first adder; and
an output of the second sub-register is coupled to the feedback terminal of the second adder.

5. The XIU-accumulating register according to claim 1, wherein the first accumulating unit has a multi-bit accumulating structure.

6. The XIU-accumulating register according to claim 5, wherein the first adder is a multi-bit adder and an adder for each bit corresponds to one of the first register.

7. The XIU-accumulating register according to claim 1, wherein the XIU-accumulating register further comprises a clock-signal-receiving terminal for receiving a clock signal;
at a rising edge phase or a falling edge phase of each clock cycle of the clock signal, the first register outputs the accumulated result of the fractional bit data and the carry bit data of the accumulated result of the fractional bit data, and the second register outputs the accumulated result of the integer bit data.

8. The XIU-accumulating register according to claim 1, wherein the accumulated variable is consisted of multi-bit binary values.

9. A XIU-accumulating register circuit, comprising a cascade of XIU-accumulating registers,
wherein the XIU-accumulating register comprises a first accumulating unit and a second accumulating unit
the first accumulating unit comprises a first adder and a first register; the first adder is configured to accumulate fractional bit data of an accumulated variable, and the first register is configured to store an accumulated result of the fractional bit data and carry bit data of the accumulated result of the fractional bit data;
the second accumulating unit comprises a second adder and a second register; the second adder is configured to accumulate integer bit data of the accumulated variable, and the second register is configured to store an accumulated result of the integer bit data;
wherein the first register of the first accumulating unit is coupled to the second adder of the second accumulating unit to, in a next clock cycle, propagate the carry bit data of the accumulated result of the fractional bit data in a current clock cycle to the integer bit data for accumulation.

10. (canceled)

11. The XIU-accumulating register circuit according to claim 9, wherein each of the first adder and the second adder comprises an input terminal, a feedback terminal, and an output terminal;
an input terminal of the first register is coupled to the output terminal of the first adder, and an output terminal of the first register is coupled to the feedback terminal of the first adder and the feedback terminal of the second adder;
an input terminal of the second register is coupled to the output terminal of the second adder, and an output terminal of the second register is coupled to the feedback terminal of the second adder;
wherein the input terminal of the first adder receives the fractional bit data of the accumulated variable, and the input terminal of the second adder receives the integer bit data of the accumulated variable.

12. The XIU-accumulating register circuit according to claim 11, wherein the first register comprises a first sub-register and a second sub-register; and
wherein the first sub-register is configured to store the accumulated result of the fractional bit data, and the second sub-register is configured to store the carry bit data of the accumulated result of the fractional bit data.

13. The XIU-accumulating register circuit according to claim 12, wherein the output terminal of the first register is coupled to the feedback terminal of the first adder and the feedback terminal of the second adder so that:
an output terminal of the first sub-register is coupled to the feedback terminal of the first adder; and
an output of the second sub-register is coupled to the feedback terminal of the second adder.

14. The XIU-accumulating register circuit according to claim 9, wherein the first accumulating unit has a multi-bit accumulating structure.

15. The XIU-accumulating register circuit according to claim 14, wherein the first adder is a multi-bit adder and an adder for each bit corresponds to one of the first register.

16. The XIU-accumulating register circuit according to claim 9, wherein the XIU-accumulating register further comprises a clock-signal-receiving terminal for receiving a clock signal;
at a rising edge phase or a falling edge phase of each clock cycle of the clock signal, the first register outputs the accumulated result of the fractional bit data and the carry bit data of the accumulated result of the fractional bit data, and the second register outputs the accumulated result of the integer bit data.

17. The XIU-accumulating register circuit according to claim 9, wherein the accumulated variable is consisted of multi-bit binary values.

18. An electronic device, wherein comprising the XIU-accumulating register circuit according to claim 9.
